(19) United States
(12) Patent Application Publication
(10) Pub. No.: US 2016/0278283 A1
(43) Pub. Date: Sep. 29, 2016

(54) Debris Clamping Rake Device

(71) Applicant: Earl W. Hebert, Sr., Fairhaven, MA (US)

(72) Inventor: Earl W. Hebert, Sr., Fairhaven, MA (US)

(21) Appl. No.: 14/669,147

(22) Filed: Mar. 26, 2015

(51) Int. Cl. A01D 11/06; A01D 7/02

(52) U.S. Cl. CPC A01D 11/06; A01D 7/02

(57) ABSTRACT

A debris clamping rake device clamps and picks up debris such as leaves, twigs, sticks, and the like while raking. The device includes each of a pair of heads having a plurality of tines coupled to and extending from a respective base section of the head. Each of a pair of handles has a respective base end coupled to an associated one of the heads such that each handle extends from the associated one of the heads. Collars are laterally positioned and pivotally coupled together such that the collars pivot in parallel planes with respect to each other. The handles are inserted through the collars wherein the handles are pivotally coupled with the main sections of the heads being positionable in substantially parallel spaced relationship defining a first gap between opposed respective first surfaces of the heads and defining a second gap between opposed respective second surfaces of the heads.

### BACKGROUND OF THE DISCLOSURE

### Field of the Disclosure

The disclosure relates to rake devices and more particularly pertains to a new rake device for clamping and picking up debris such as leaves, twigs, sticks, and the like while raking.

### SUMMARY OF THE DISCLOSURE

An embodiment of the disclosure meets the needs presented above by generally comprising each of a pair of heads having a plurality of tines coupled to and extending from a respective base section of the head. Each of a pair of handles has a respective base end coupled to an associated one of the heads such that each handle extends from the associated one of the heads. Collars are laterally positioned and pivotally coupled together such that the collars pivot in parallel planes with respect to each other. Each of the handles is inserted through an associated one of the collars wherein the handles are pivotally coupled with the main sections of the heads being positionable in substantially parallel spaced relationship defining a first gap between opposed respective first surfaces of the heads and defining a second gap between opposed respective second surfaces of the heads.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a debris clamping rake device according to an embodiment of the disclosure.

FIG. 2 is a front view of an embodiment of the disclosure.

FIG. 3 is a side view of an embodiment of the disclosure in a closed position.

FIG. 4 is a side view of an embodiment of the disclosure in an open position.

FIG. 5 is a detailed top front side perspective view of an embodiment of the disclosure.

FIG. 6 is a detailed side view of meshed tines of an embodiment of the disclosure.

### DESCRIPTION OF THE PREFERRED EMBODIMENT

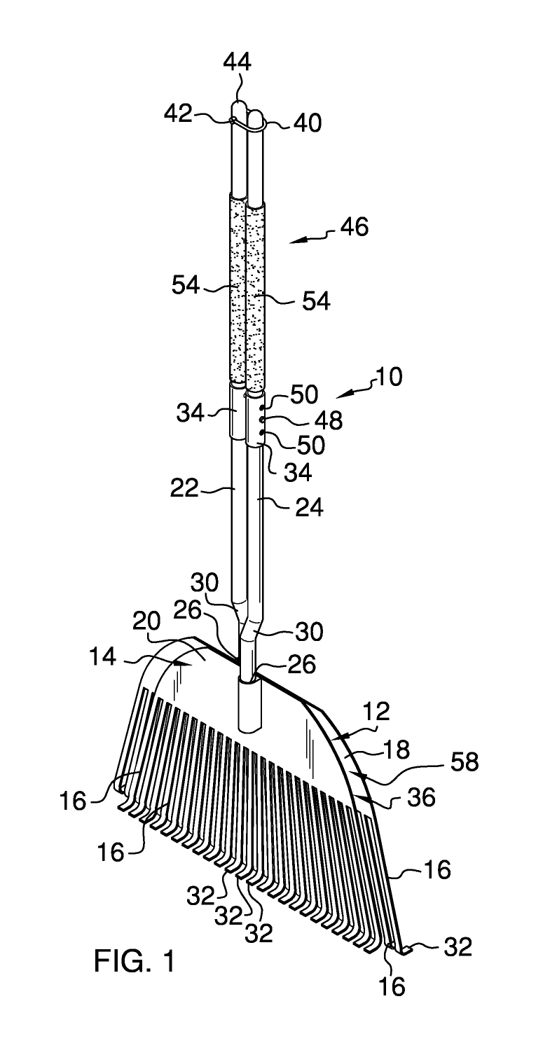

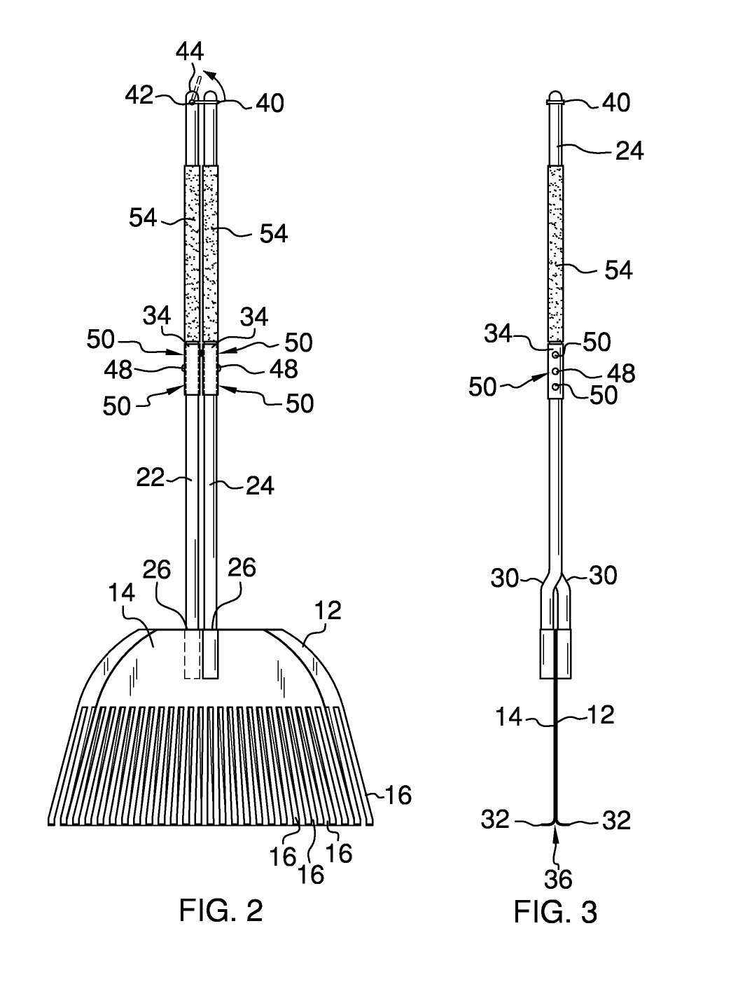

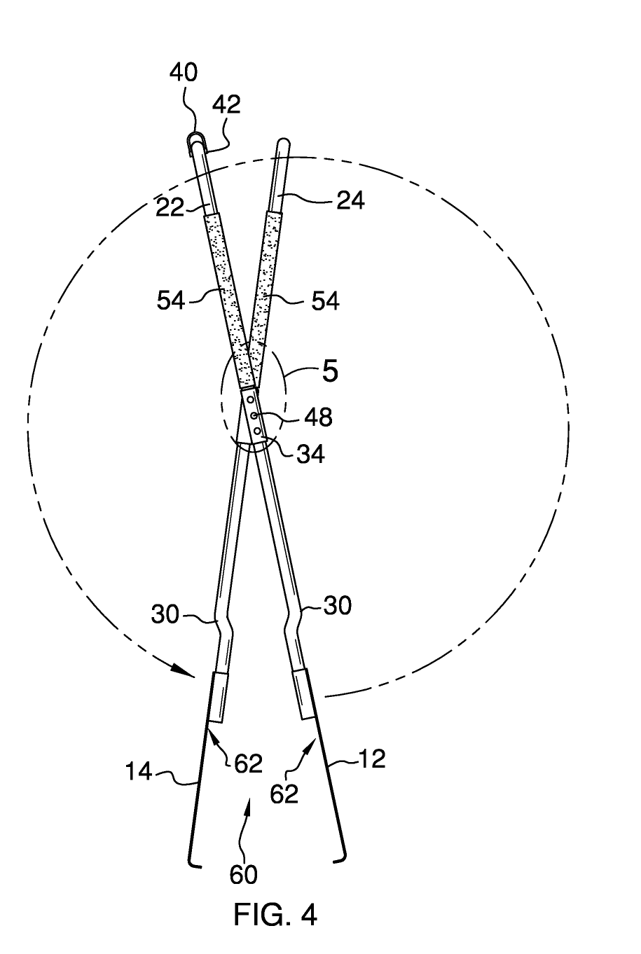

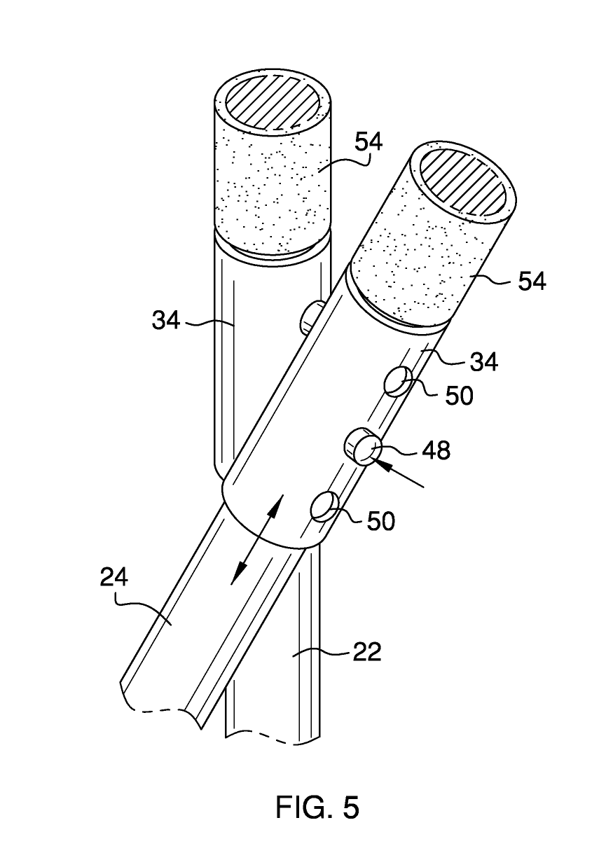

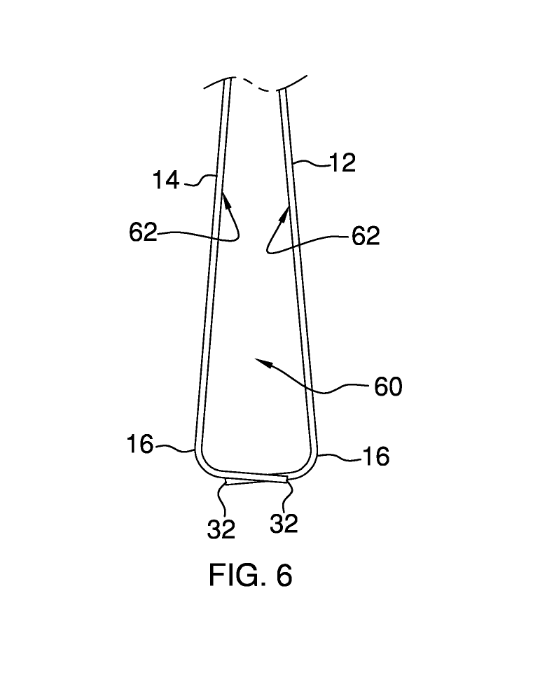

With reference now to the drawings, and in particular to FIGS. 1 through 6 thereof, a new rake device embodying the principles and concepts of an embodiment of the disclosure and generally designated by the reference numeral 10 will be described.

As best illustrated in FIGS. 1 through 6, the debris clamping rake device 10 generally comprises a pair of heads 12,14. Each head 12,14 has a plurality of tines 16 coupled to and extending from a respective base section 18,20 of the respective head 12,14. Each of a pair of handles 22,24 has a respective base end 26 coupled to an associated one of the heads 12,14 such that each handle 22,24 extends from the associated one of the heads 12,14. Each of the handles 22,24 has a respective offset section 30 positioned proximate the base end 26 of the handle 22,24.

Each of a pair of collars 34 is laterally positioned and pivotally coupled together such that the collars 34 pivot in parallel planes with respect to each other. The collars 34 pivot to allow full rotation of each collar 34 relative to the other. Each of the handles 22,24 is inserted through an associated one of the collars 34 wherein the handles 22,24 are pivotally coupled with the base sections 18,20 of the heads 12,14 being positioned in substantially parallel spaced relationship defining a first gap 36 between opposed respective first surfaces 58 of the heads 12,14. By rotation of the collars 34, the heads 12,14 are alternatively positionable in substantially parallel spaced relationship defining a second gap 60 between opposed respective second surfaces 62 of the heads 12,14. Thus, the heads 12,14 are configured for clamping debris 38 between the heads 12,14 by manipulation of the handles 22,24. Each of the tines 16 of each of the heads 12,14 has a distal section 32 relative to the base section 18,20 of the respective head 12,14. The distal section 32 is transverse to the base section 18,20 of the respective head 12,14 and extends outwardly away from the first gap 36 when the first surfaces 58 are oppositionally positioned. Thus, a user may grasp the handles 22,24 and use either head 12,14 in the manner of a conventional rake. One of the heads 12 may have a width greater than a width of the other head 14. The tines 16 of each head 12,14 and extend inwardly through the second gap 60 between the second surfaces 62 of the heads 12,14 are meshed when the heads 12,14 are pivoted such that the second surfaces 62 of the heads 12,14 are oppositionally positioned.

A loop 40 has a coupled end 42 pivotally coupled to one of the handles 22. The loop 40 is positioned proximate a free end 44 of the one of the handles 22. The loop 40 is positionable to extend around a second one of the handles 24 when the handles 22,24 are laterally aligned defining a closed position 46 for the heads 12,14 such that the loop 40 secures the handles 22,24 in the closed position 46.

Each of a pair of pins 48 is coupled to and extends from an associated one of the handles 22,24. Each pin 48 may be biased in a conventional manner to be urged to extend outwardly from the associated handle 22, 24. Each of the collars 34 is structured to include a plurality of linearly aligned apertures 50 extending through the collar 34. Each pin 48 is positionable to extend through a selectable one of the linearly aligned apertures 50 when the associated handle 22,24 is inserted through the associated collar 34 wherein a pivot point 52 relative to the base ends 26 of the handles 22,24 is adjustable. Each of a pair of grips 54 is coupled to an associated one of the handles 22,24 to facilitate secure and comfortable grasping and manipulation of the handles 22,24.

In use, the handles 22,24 are manipulated to position the heads 12,14 as desired for raking or clamping of yard debris or the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A debris clamping rake device comprising:
a pair of heads, each said head having a plurality of tines coupled to and extending from a respective main section of said head,
a pair of handles, each of said handles having a respective base end being coupled to an associated one of said heads such that each said handle extends from said associated one of said heads;
a pair of collars, said collars being laterally positioned and pivotally coupled together such that said collars pivot in parallel planes with respect to each other, each of said handles being inserted through an associated one of said collars wherein said handles are pivotally coupled with said main sections of said heads being positionable in substantially parallel spaced relationship defining a gap between opposed respective first surfaces of said heads, said main sections being alternatively positionable in substantially parallel spaced relationship defining a second gap between opposed respective second surfaces of said heads, said heads being configured for clamping debris between said heads by manipulation of said handles; and
a loop having a coupled end pivotally coupled to one of said handles, said loop being positioned proximate a free end of said one of said handles, said loop being positionable to extend around a second one of said handles when said handles are laterally aligned defining a closed position for said heads such that said loop secures said handles in said closed position.

2. The device of claim 1, further comprising each of said tines of each of said heads having a distal section relative to said main section of said head, said distal section being transverse to said main section of said head and extending outwardly away from said gap between said opposed first surfaces when said heads are pivoted such that said first surfaces of said heads are oppositionally positioned.

3. The device of claim 1, further comprising each of said tines of each of said heads having a distal section relative to said main section of said head, said distal section being transverse to said main section of said head and said tines extending inwardly through said gap between said second surfaces of said heads and being meshed when said heads are pivoted such that said second surfaces of said heads are oppositionally positioned.

4. (canceled)

5. The device of claim 1, further comprising:
a pair of pins, each of said pins being coupled to and extending from an associated one of said handles; and
each of said collars being structured to include a plurality of linearly aligned apertures extending through said collar, each said pin being positionable to extend through a selectable one of said linearly aligned apertures when said associated handle is inserted through said associated collar wherein a pivot point relative to said base ends of said handles is adjustable.

6. The device of claim 1, further comprising a pair of grips, each of said grips being coupled to an associated one of said handles.

7. A debris clamping rake device comprising:
a pair of heads, each said head having a plurality of tines coupled to and extending from a respective main section of said head,
a pair of handles, each of said handles having a respective base end being coupled to an associated one of said heads such that each said handle extends from said associated one of said heads, each of said handles having a respective offset section positioned proximate said base end of said handle;
a pair of collars, said collars being laterally positioned and pivotally coupled together such that said collars pivot in parallel planes with respect to each other, each of said handles being inserted through an associated one of said collars wherein said handles are pivotally coupled with said main sections of said heads being positionable in substantially parallel spaced relationship defining a gap between opposed respective first surfaces of said heads, said main sections being alternatively positionable in substantially parallel spaced relationship defining said gap between opposed respective second surfaces of said heads, said heads being configured for clamping debris between said heads by manipulation of said handles, each of said tines of each of said heads having a distal section relative to said main section of said head, said distal section being transverse to said main section of said head and extending outwardly away from said gap when said heads are pivoted such that said respective first surfaces of said heads are oppositionally positioned, said tines extending inwardly through said gap and being meshed when said heads are pivoted such that said respective second surfaces of said heads are oppositionally positioned;
a loop having a coupled end pivotally coupled to one of said handles, said loop being positioned proximate a free end of said one of said handles, said loop being positionable to extend around a second one of said handles when said handles are laterally aligned defining a closed position for said heads such that said loop secures said handles in said closed position;
a pair of pins, each of said pins being coupled to and extending from an associated one of said handles;
each of said collars being structured to include a plurality of linearly aligned apertures extending through said collar, each said pin being positionable to extend through a selectable one of said linearly aligned apertures when said associated handle is inserted through said associated collar wherein a pivot point relative to said base ends of said handles is adjustable; and
a pair of grips, each of said grips being coupled to an associated one of said handles.
